(19) United States
(12) Patent Application Publication
(10) Pub. No.: US 2008/0256495 A1
(43) Pub. Date: Oct. 16, 2008

(54) Personalized user interface

(75) Inventors: Kynan Antos, Seattle, WA (US); Todd Roger Headrick, Kirkland, WA (US); Cyra S. Richardson, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/784,880

(22) Filed: Apr. 10, 2007

(51) Int. Cl. G06F 3/00; G06F 3/048

(52) U.S. Cl. 715/866; 715/811

(57) ABSTRACT

A user interface of a computing system is personalized based on whether the computing system is used in a home environment, a business environment, etc. In one implementation, user interface content is stored that is defined for a plurality of consumer-usage environments, such as the home and business environment. The computing system identifies its consumer-usage environment, whether it is a home environment, a business environment, etc. The computing system then personalizes a user interface that is provided to a user based the environment in which it is being or will be used. To personalize the user interface, the computing system identifies the proper user interface content defined for the consumer-usage environment, and provides the user interface based on the proper user interface content.

### BACKGROUND

Hardware and software manufacturers are conscious of the experience a user has when using their products. A software manufacturer, for example, may be concerned with the experience a user has in installing software on one or more computing systems, and in using the software after it is installed. When installing a software application, an installation function or program provides a user interface (sometimes referred to as a Graphical User Interface (GUI)) to guide the user through the installation process. The user typically proceeds through multiple screens or windows of the user interface to acknowledge software license terms, to select particular properties, to configure network settings, and to enter information such as a product key, a time and time zone setting, etc. After installation, the software application provides a user interface that allows the user to perform one or more functions provided by the software application.

One problem with present user interfaces provided by software and hardware is that the nomenclature and other aspects of the user interfaces are programmed to be generalized based on what is common or proper in the technology. For instance, a user of a product is aptly referred to as a “user” (or “user1”, “user 2”, etc) by a user interface. A computer on a network is typically referred to as a “client” or a “computer” by a user interface. The user interface is technology centric and general so that it may be used in a home environment, a business environment, or another type of environment, without being tailored to one of those types of environments. For instance, if a user interface referred to a user as an “employee”, then that nomenclature would be appropriate for some types of businesses but would not be appropriate for most home uses. Thus, more generalized nomenclature and other interface aspects are used.

When software or hardware is shipped from the manufacturer, the user interface is presently the same regardless of whether the software or hardware will be used in home environment, a business environment, or another type of environment. When the end user receives the software or hardware, the end user may personalize the otherwise general user interface to a certain extent, such as by selecting font styles and sizes, changing properties, etc. However, these changes are made by the end user and the changes depend on the individual taste of the end user. The generalized user interfaces provided by present software or hardware manufacturers do not foster any type of emotional or meaningful connection with the user, which may diminish the overall user experience.

### SUMMARY

Embodiments of the invention solve the above and other problems by personalizing a user interface provided by a computing system based on the consumer-usage environment (e.g., home or business) of the computing system. The user interface can be personalized based on the consumer-usage environment in a variety of ways. For instance, the nomenclature of a user interface may change based on whether the computing system is being used in a home or in a business. In a home environment, the user interface may use nomenclature such as “family member”, “father”, “daughter”, etc. In a business environment, the user interface may use nomenclature such as “employee”, “manager”, etc. By changing the user interface based on the consumer-usage environment of the computing system, the experience of a user may be enhanced by having a more emotional or meaningful connection with the software or hardware.

One embodiment includes a personalized user interface that is provided through a computing system. In accordance with this embodiment, user interface content is defined and stored for a plurality of consumer-usage environments. As an example, there may be user interface content stored for a home environment operable to provide a user interface (e.g., a GUI) when the computing system is used in a home environment. Similarly, there may be user interface content stored for a business environment that is operable to provide a user interface when the computing system is used in a business environment. In accordance with this embodiment, a consumer-usage environment in which the computing system is being or will be used is identified based on some information or input. As an example, the computing system may query a user as to whether the computing system will be used in a home environment or a business environment. Further, a user interface provided by the computing system may be personalized based on the environment in which the computing system is being or will be used. To personalize the user interface, the computing system identifies the proper user interface content defined for the consumer-usage environment of the computing system, and provides the user interface based on the proper user interface content.

Personalizing the user interface may take on many desired forms. In one example, personalizing the user interface may include displaying a window, menu, dialog box, or other display item using nomenclature that is defined for a home environment or a business environment. In another example, personalizing the user interface may include displaying colors that are defined for a home environment or a business environment. In another example, personalizing the user interface may include playing audio that is defined for a home environment or a business environment. Personalizing the user interface in these and other ways based on the consumer-usage environment of the computing system may create a more emotional or meaningful connection with the user which can make the user's experience more enjoyable.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Also, the claimed subject matter is not limited to implementations that solve any or all of the disadvantages described in the above Background.

### DESCRIPTION OF THE DRAWINGS

The same reference number represents the same element or same type of element on all drawings.

FIG. 1 illustrates a computing system in an example embodiment.

FIG. 2 is a flowchart illustrating a method of providing a personalized user interface in an example embodiment.

FIG. 3 is a flowchart illustrating a method of identifying a consumer-usage environment of a computing system in an example embodiment.

FIG. 4 illustrates a window that provides multiple environment options to a user in an example embodiment.

FIG. 5 is a flowchart illustrating a method of personalizing a user interface of a computing system in an example embodiment.

FIG. 6 illustrates another computing system in an example embodiment.

FIG. 7 illustrates a HELP menu for a home environment in an example embodiment.

FIG. 8 illustrates a HELP menu for a business environment in an example embodiment.

### DETAILED DESCRIPTION

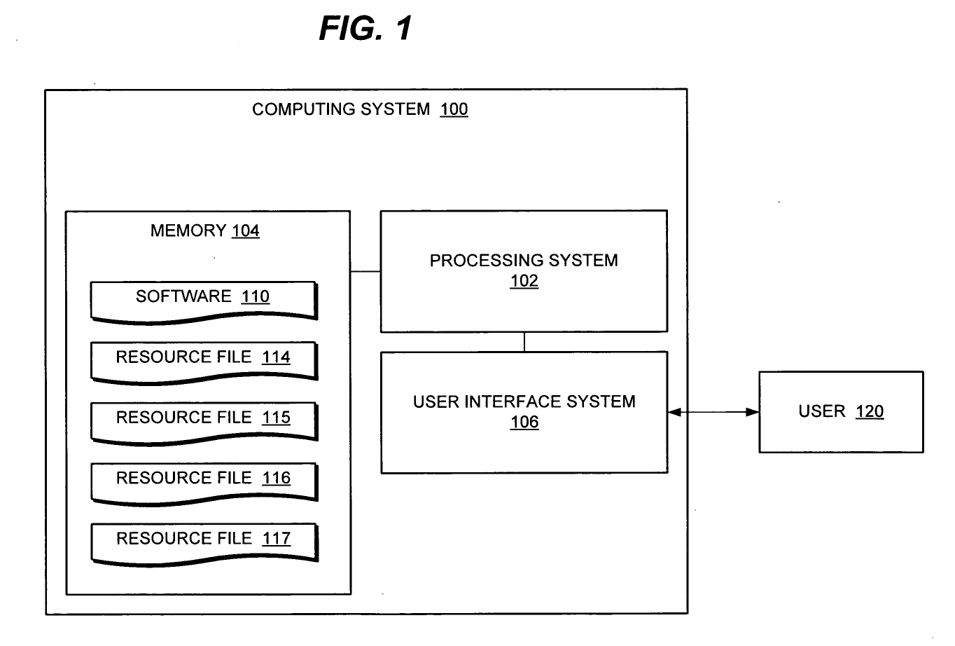

FIGS. 1-8 and the following description depict specific embodiments to teach those skilled in the art how to make and use the subject matter provided herein. For the purpose of teaching the embodiments, some conventional aspects of these embodiments have been simplified or omitted. Those skilled in the art will appreciate that the features described below can be combined in various ways to form multiple variations of the embodiments.

FIG. 1 illustrates a computing system 100 in an example embodiment. Computing system 100 may represent a programmed general purpose computer such as a PC or a server, or may represent a distributed type system. Computing system 100 includes a processing system 102, memory 104, and a user interface system 106. Processing system 102 may comprise a computer microprocessor, a logic circuit, or some other processing device. Processing system 102 may be distributed among multiple processing devices. Memory 104 may comprise a disk, tape, integrated circuit, server, or some other memory device. Memory 104 may be distributed among multiple memory devices. User interface system 106 may comprise a keyboard, a mouse, a voice recognition interface, a graphical display, a touchscreen, or some other type of user device. User interface system 106 is adapted to present or provide a user interface to user 120. The user interface as described herein represents the content provided to user 120 through user interface system 106. For instance, if user interface system 106 includes a speaker, then the user interface may comprise audio played on the speaker.

In this embodiment, memory 104 stores software 110 and a plurality of resource files 114-117. Software 110 comprises any instructions or code adapted to provide a function when executed by processing system 102. Software 110 may comprise system software, such as an operating system, or may comprise an application or applications, such as word processing applications, spreadsheets, etc. Resource files 114-117 comprise files that include resource data and a resource map. Resource data comprises any data structures, templates, definition procedures, management routines, icon maps, etc, associated with a particular resource of a user interface, such as a menu, window, dialog box, etc. Although the term resource file is used, other types of files or user interface content may be used to create a personalized user interface as discussed herein.

As stated in the Background, some computing systems provide a generalized user interface that may be used in a variety of environments. For instance, the same generalized user interface may be used in a home environment as well as a business environment. The nomenclature and other aspects of the user interface are general in such a way that the user interface can be used in different environments. According to embodiments provided herein, the user interface provided by computing system 100 is personalized based on the environment in which the computing system 100 is used or will be used. This environment is also referred to herein as the consumer-usage environment.

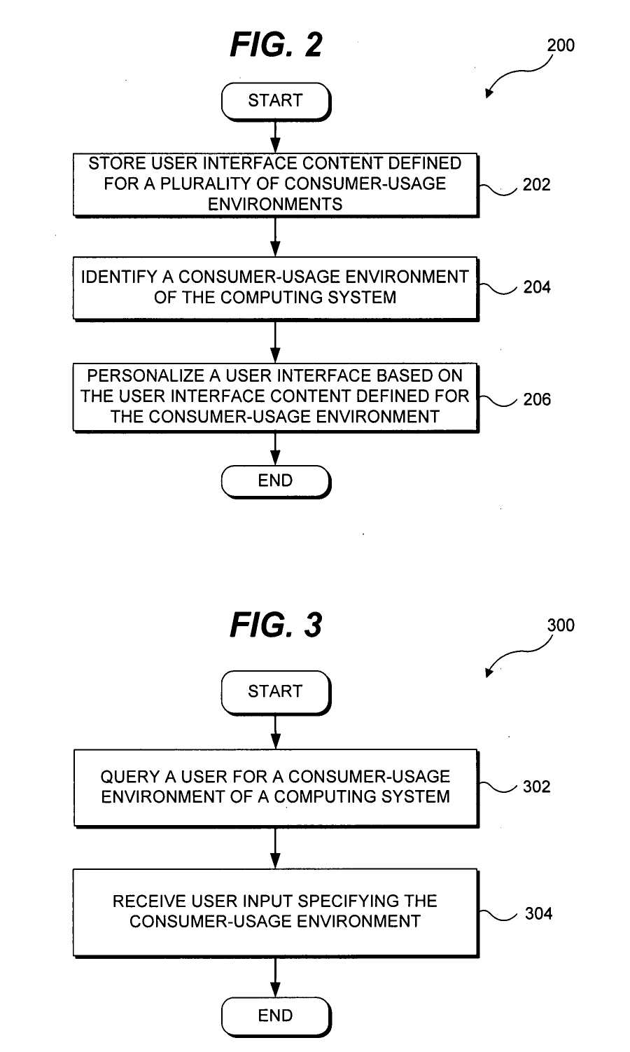

FIG. 2 is a flowchart illustrating a method 200 of providing a personalized user interface in an example embodiment. The steps of the flowchart in FIG. 2 are not all inclusive and may include other steps not shown.

In step 202 of method 200, computing system 100 stores user interface content defined for a plurality of consumer-usage environments. The consumer-usage environment refers to whether the computing system is being used in a home environment or a business environment. A business environment may comprise a small business environment, a mid-market business environment, an enterprise environment, a non-profit environment, a governmental environment, or another other type of non-home environment. Computing system 100 may also be used in other environments that are not particularly spelled out herein.

The user interface content comprises the data or files used by computing system 100 to provide an interface to a user. The user interface content may take on many desired forms, one of which is resource files 114-117 shown in FIG. 1. Instead of having generalized user interface content as with some computing systems and software, computing system 100 stores different user interface content for the different environments in which it will be used. The user interface content may be defined by the manufacturer of computing system 100, by the developer of software 110, or by another development entity.

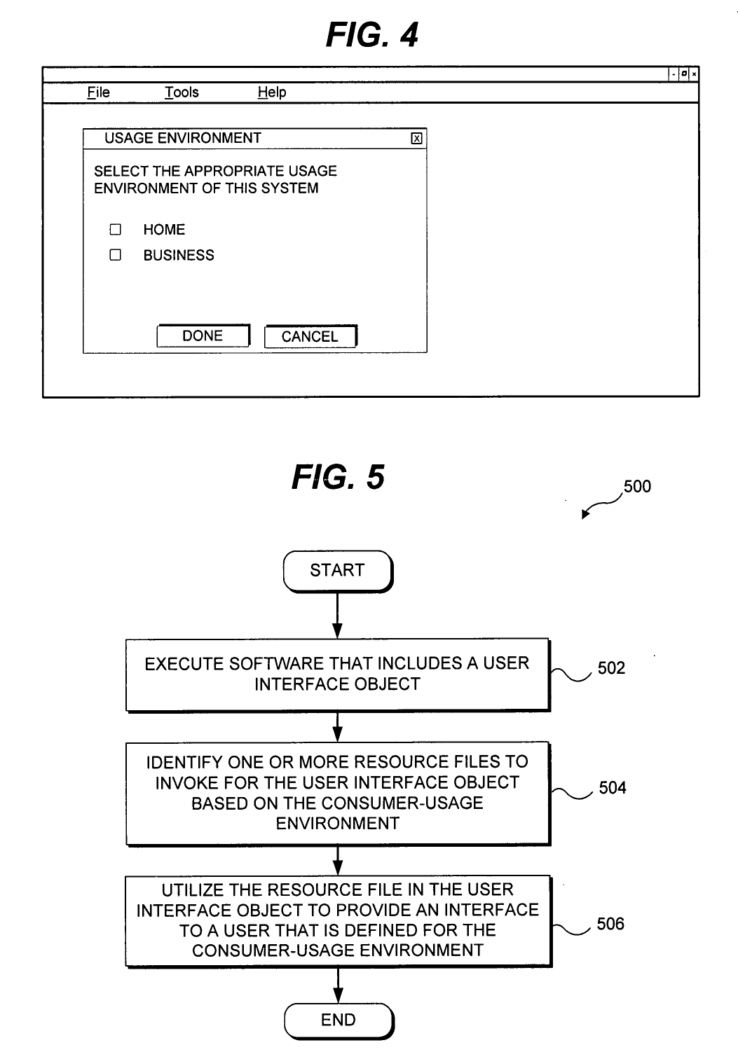

In step 204, computing system 100 identifies its consumer-usage environment. Computing system 100 may identify its environment in various ways, one example of which is shown in FIG. 3. FIG. 3 is a flowchart illustrating a method 300 of identifying a consumer-usage environment of a computing system in an example embodiment. In step 302 of method 300, computing system 100 queries user 120 for the consumer-usage environment of computing system 100 (see also FIG. 1). Computing system 100 may provide a user interface that queries user 120 to enter the appropriate consumer-usage environment. In one example, computing system 100 may display a window providing multiple environment options that are selectable by user 120, such as illustrated in FIG. 4. In step 304 (see FIG. 3), computing system 100 receives user input specifying the consumer-usage environment for computing system 100. The user input may comprise a selection of one of the environment options illustrated in FIG. 4 although other environment options (not shown) may be selected. This method 300 of querying the user may occur during a process of installing software on computing system 100, or may occur at other times while performing other tasks.

In an alternative embodiment, computing system 100 may automatically determine its usage environment. For instance, computing system 100 may identify the usage environment based on information on a network to which computing system 100 is connected. Assume for example that computing system 100 is connected to a network that is serving a numberXof client machines. Computing system 100 may determine that the usage environment is a home environment if the number X is less than a threshold number of machines, such as less than five machines. Computing system 100 may determine that the usage environment is a small business environment if the number X is within a range, such as between five machines and fifty machines. Computing system 100 may further determine that the usage environment is a mid-market business environment if the number X is within another range, such as between fifty machines and five hundred machines. Computing system 100 may alternatively determine its usage environment based on other aspects of the network, such as one or more network addresses (or IP addresses) used in the network, one or more MAC addresses used in the network, etc. Computing system 100 may determine its usage environment in other ways.

Responsive to identifying the consumer-usage environment of computing system 100 in step 204 of FIG. 2, computing system 100 personalizes a user interface being provided to user 120 through user interface system 106 based on the user interface content defined for the consumer-usage environment of computing system 100 in step 206. Personalizing the user interface means that the user interface may change or may be different for different consumer-usage environments, such as a home environment, a business environment, etc. Computing system 100 is advantageously able to automatically personalize the user interface that it provides based on its identified environment. Personalizing the user interface based on the consumer-usage environment of computing system 100 may provide an improved user experience. Instead of a generalized user interface, computing system 100 may provide a user interface that is related to the environment in which computing system 100 is being used, and user 120 may thus have a more emotional or meaningful connection with computing system 100 and consequently a more enjoyable computing experience. Those skilled in the art understand that user 120 may further personalize the user interface provided by computing system 100 based on his/her individual tastes.

In one example of computing system 100 providing a personalized user interface, computing system 100 may display a window, a menu, a dialog box, or some other display item using nomenclature that is defined for the consumer-usage environment of computing system 100. For instance, in a home environment, computing system 100 may display a window using the terms “father” and “daughter”, which are applicable to the home environment. In a business environment, computing system 100 may display a window using the terms “manager” and “employee”, which are applicable to the business environment. There may be a different nomenclature used in different environments, so computing system 100 is able to change the nomenclature used in a user interface based on the consumer-usage environment.

In another example of computing system 100 providing a personalized user interface, computing system 100 may display a color or colors that are defined for the consumer-usage environment of computing system 100. In another example, computing system 100 may play audio that is defined for the consumer-usage environment of computing system 100. There are many other examples of how computing system 100 may provide a personalized user interface for a particular environment.

Computing system 100 may operate in the following manner to personalize the user interface based on the consumer-usage environment of computing system 100 as described in step 206 above. FIG. 5 is a flowchart illustrating a method 500 of personalizing a user interface of a computing system in an example embodiment. In step 502 of method 500, processing system 102 (in computing system 100) executes software 110 (see FIG. 1) that includes a user interface object. A user interface object comprises any code, instructions, or data adapted to provide a user interface, such as a menu, a window, a dialog box, or some other interface function. The user interface object invokes one or more resource files 114-117 to provide the user interface. For instance, one resource file may be an English language file comprising strings used for an English language user interface. Another resource file may be a Spanish language file comprising strings used for a Spanish language user interface. Yet another resource file may be a French language file comprising strings used for a French language user interface.

In step 504 of method 500, processing system 102 identifies one or more resource files 114-117 to invoke for the user interface object based on the consumer-usage environment of computing system 100. Processing system 102 then utilizes the resource file or resource files in the user interface object to provide an interface to user 120 (through user interface system 106) that is defined for the consumer-usage environment of computing system 100 in step 506. This functionality is an improvement over other computing systems. In some computing systems, a user interface object invokes or references a particular resource file and that resource file is utilized to provide the user interface. For example, if the user interface object invokes an English language resource file, then the English language resource file is located and is utilized to provide the user interface.

According to method 500, processing system 102 identifies which resource file to invoke for a user interface object based on the usage environment of computing system 100. Consequently, if a user interface object invokes an English language resource file, then processing system 102 identifies which English language resource file to invoke based on whether computing system 100 is being used in a home environment, a business environment, etc. Instead of having one English language resource file generalized for multiple usage environments, there may be multiple English language resource files tailored to different usage environments, such as an English language resource file for a home environment, and an English language resource file for a business environment. After identifying the proper resource file, processing system 102 utilizes the resource file to provide the interface to user 120 that is defined for the present environment of computing system 100.

In method 500, processing system 102 provides an interface to user 120 that is defined for the consumer-usage environment of computing system 100 through resource files 114-117 or other user interface content that are defined by the manufacturer of computing system 100, by the developer of software 110, or by another development entity. When computing system 100 is operating in its intended environment, computing system 100 may also dynamically update one or more of resource files 114-117 or other user interface content based on input from a user. For example, if computing system 100 is operating in a particular environment, such as a home environment, then user 120 may input data into computing system 100 that represents a particular nomenclature used in this environment or a nomenclature desired by user 120. For instance, user 120 may define his/her role or name on the home network as “father” rather than “user1” or “admin”. Similarly, user 120 may define that another user on the home network is termed “daughter” rather than user2. Responsive to receiving the user input indicating nomenclature used in the consumer-usage environment of computing system 100, computing system 100 updates the resource file 114-117 or other user interface content based on the user input. The user interface provided by computing system 100 can thus be further personalized for the consumer-usage environment by dynamically updating resource files 114-117 or other user interface content.

### EXAMPLE

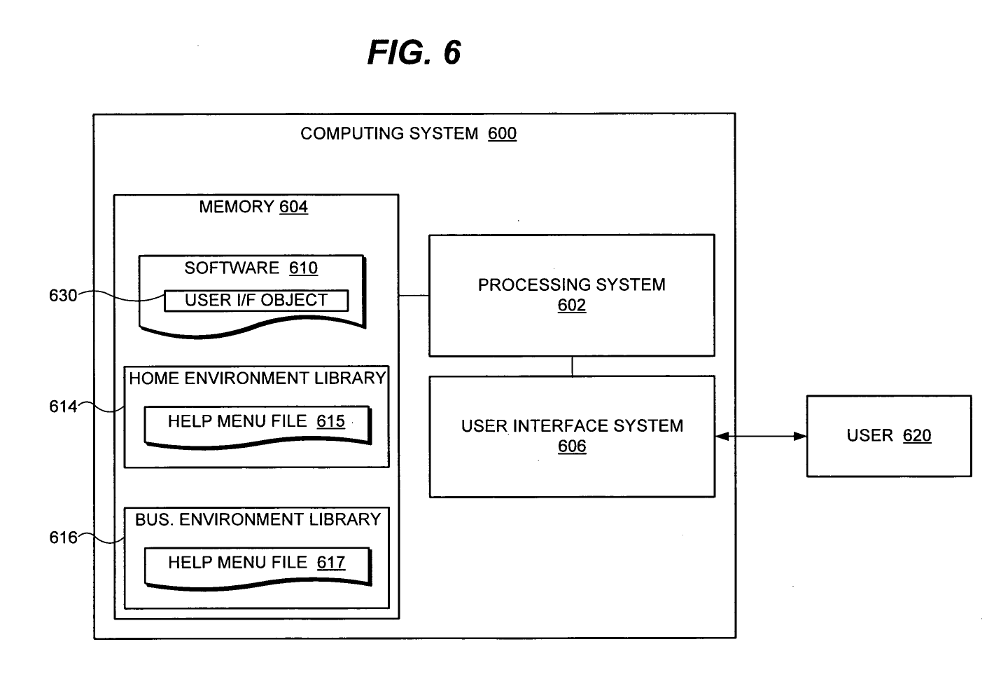

FIG. 6 illustrates another computing system 600 in an example embodiment. Computing system 600 is substantially similar to computing system 100 shown in FIG. 1. Computing system 600 includes a processing system 602, memory 604, and a user interface system 606. Memory 604 stores software 610 that, when executed by a processing system 602, is adapted to provide a HELP menu to a user 620 along with other features or functions. Software 610 may comprise a word processing application, an Internet browser, an operating system for a server or a PC, or any other software that provides a HELP menu.

Memory 604 includes a home environment library 614 and a business environment library 616. Home environment library 614 stores resource files and other files defined for a home environment. In this embodiment, home environment library 614 stores a HELP menu file 615 defined for a home environment, and may store other files not shown in FIG. 6. In a similar manner, business environment library 616 stores resource files and other files defined for a business environment. In this embodiment, business environment library 616 stores a HELP menu file 617 defined for a business environment, and may store other files not shown in FIG. 6. Memory 604 may include other libraries defined for other consumer-usage environments of computing system 600.

When in operation, processing system 602 identifies whether its usage is in a home environment or a business environment. As described in previous embodiments, processing system 602 may query user 620 to determine whether its usage is in a home environment or a business environment, or may automatically determine its environment based on other information, such as the network to which computing system 600 is connected. Processing system 602 may query user 620 when software 610 is being installed on computing system 600. For instance, software 610 may include an installation function that automatically queries user 620 as to whether software 610 will be used in a home or a business. In further operation, processing system 602 executes software 610 responsive to a request from user 620 to run software 610.

Assume that during operation of software 610, user 620 selects a HELP menu provided by software 610. As part of providing the HELP menu, software 610 includes a user interface object 630 that invokes a HELP menu file. Processing system 602 first identifies the proper HELP menu file to invoke. To identify the proper HELP menu file, processing system 602 determines which library 614 or 616 to access based on the consumer-usage environment of computing system 600. If computing system 600 is used in a home environment, then processing system 602 accesses home environment library 614, and more particularly, accesses HELP menu file 615 in home environment library 614. If computing system 600 is used in a business environment, then processing system 602 accesses business environment library 616, and more particularly, accesses HELP menu file 617 in business environment library 616. When the proper HELP menu file 615 or 617 is identified, user interface object 630 utilizes the HELP menu file to display a HELP menu to user 620 through user interface system 606.

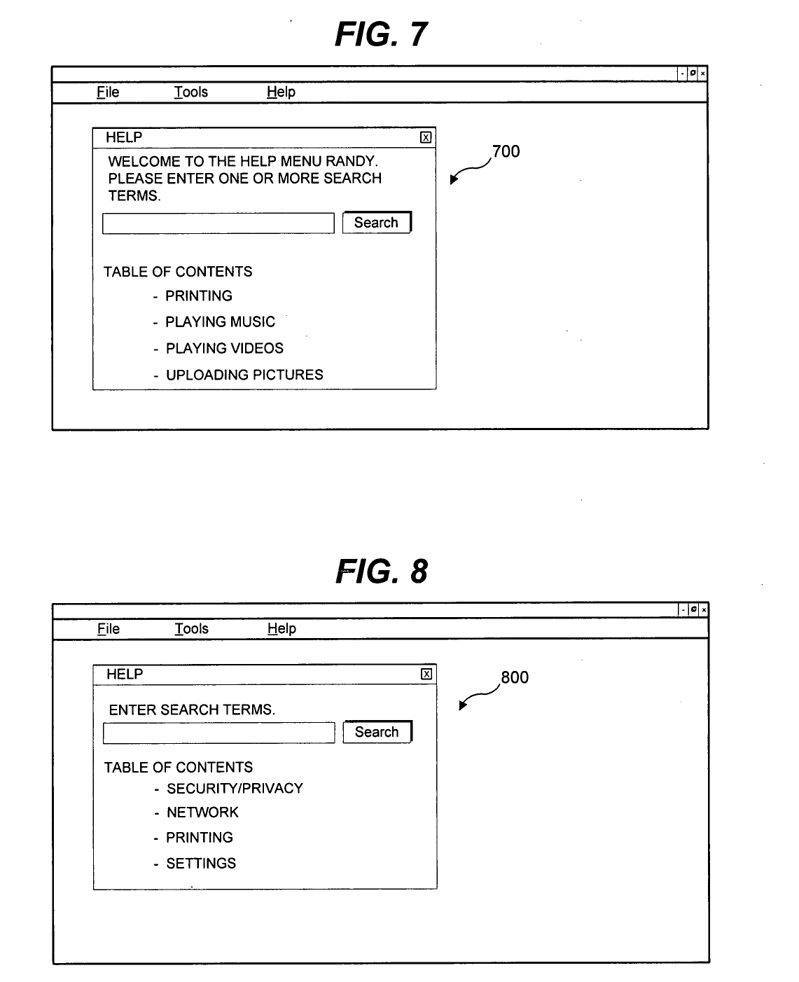

Assume for one example that the consumer-usage environment of computing system 600 is a home environment. In such an example, user interface object 630 utilizes HELP menu file 615 from home environment library 614. FIG. 7 illustrates a HELP menu 700 for a home environment in an example embodiment. HELP menu 700 is personalized for home usage in a desired manner. For instance, HELP menu 700 refers to user 620 by name (Randy) and may provide instructions in friendlier manner. HELP menu 700 also displays a table of contents that features topics more likely to be searched in a HELP menu in a home environment. For instance, the table of contents features the topics of printing, playing music, playing videos, and uploading pictures. These topics may be common in a home environment, and thus may be more likely needed by a home user. HELP menu 700 may be personalized in other ways for a home environment, as this is just one illustration.

Assume for another example that the consumer-usage environment of computing system 600 is a business environment. In such an example, user interface object 630 utilizes HELP menu file 617 from business environment library 616. FIG. 8 illustrates a HELP menu 800 for a business environment in an example embodiment. HELP menu 800 is personalized for business usage in a desired manner. For instance, HELP menu 800 may not provide as many instructions on the assumption that user 620 is a sophisticated computer user, such as a network administrator. HELP menu 800 also displays a table of contents featuring topics more likely to be searched in a HELP menu in a business environment. For instance, the table of contents features the topics of security/privacy, network, printing, and settings. These topics may be common in a business environment, and thus may be more likely needed by a business user. HELP menu 800 may be personalized in other ways for a business environment, as this is just one illustration.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method of providing a personalized user interface through a computing system, the method comprising:
storing user interface content defined for a plurality of consumer-usage environments;
identifying a consumer-usage environment of the computing system; and
personalizing a user interface provided by the computing system based on the user interface content defined for the identified consumer-usage environment.

2. The method of claim 1 wherein the identified consumer-usage environment of the computing system comprises a home environment or a non-home environment.

3. The method of claim 1 wherein identifying a consumer-usage environment of the computing system comprises:
querying a user for the consumer-usage environment; and
receiving user input specifying the consumer-usage environment of the computing system.

4. The method of claim 1 wherein identifying a consumer-usage environment of the computing system comprises:
automatically identifying the consumer-usage environment of the computing system based on information on a network to which the computing system is connected.

5. The method of claim 1 wherein personalizing a user interface provided by the computing system comprises:
displaying a window, menu, or dialog box using nomenclature that is defined for the identified consumer-usage environment.

6. The method of claim 1 wherein personalizing a user interface provided by the computing system comprises:
displaying colors that are defined for the identified consumer-usage environment.

7. The method of claim 1 wherein personalizing a user interface provided by the computing system comprises:
playing audio that is defined for the identified consumer-usage environment.

8. The method of claim 1 wherein the user interface content comprises resource files and wherein personalizing a user interface provided by the computing system comprises:
executing software that includes a user interface object;
identifying at least one of the resource files to invoke for the user interface object based on the identified consumer-usage environment; and
utilizing the at least one resource file in the user interface object to provide an interface to a user that is defined for the identified consumer-usage environment.

9. A system adapted to execute a software application that includes a user interface object adapted to provide a user interface, the system comprising:
memory adapted to store resource files for a home environment and resource files for a non-home environment; and
a processing system adapted to:
identify whether the usage environment of the software application is in a home environment or a non-home environment;
identify at least one of the resource files to invoke for the user interface object based on whether the usage of the software application is in a home environment or a non-home environment; and
utilize the at least one resource file in the user interface object to provide an interface to a user that is defined for the home environment or the non-home environment.

10. The system of claim 9 wherein the processing system is further adapted to:
receive user input specifying whether the usage environment of the software application is in a home environment or a non-home environment.

11. The system of claim 9 wherein the processing system is further adapted to:
receive user input indicating nomenclature used in the home environment or the non-home environment; and
updating the at least one resource file based on the user input.

12. The system of claim 9 wherein the processing system is further adapted to:
utilize the at least one resource file in the user interface object to display a window, menu, or dialog box using nomenclature that is defined for the home environment or the non-home environment.

13. The system of claim 9 wherein the processing system is further adapted to:
utilize the at least one resource file in the user interface object to display colors that are defined for the home environment or the non-home environment.

14. The system of claim 9 wherein the processing system is further adapted to:
utilize the at least one resource file in the user interface object to play audio that is defined for the home environment or the non-home environment.

15. A computer program product adapted to provide a personalized user interface, the computer program product comprising:
computer useable medium including a computer-readable program, wherein the computer-readable program when executed on a computing system causes the computing system to:
identify whether the usage of the computing system is in a home environment or a business environment;
identify at least one user interface file defined for the home environment or at least one user interface file defined for the business environment depending on whether the usage of the computing system is in a home environment or a business environment; and
provide a user interface for the computing system based on the at least one user interface file.

16. The computer program product of claim 15 wherein the computer-readable program causes the computing system to:
receive user input specifying whether the usage of the computing system is in the home environment or the business environment.

17. The computer program product of claim 15 wherein the computer-readable program causes the computing system to:
receive user input indicating nomenclature used in the home environment or the business environment; and
update the at least one user interface file based on the user input.

18. The computer program product of claim 15 wherein the computer-readable program causes the computing system to:
provide the user interface for the computing system based on the at least one user interface file by displaying a window, menu, or dialog box using nomenclature that is defined for the home environment or the business environment.

19. The computer program product of claim 15 wherein the computer-readable program causes the computing system to:
provide the user interface for the computing system based on the at least one user interface file by displaying colors that are defined for the home environment or the business environment.

20. The computer program product of claim 15 wherein the computer-readable program causes the computing system to:
provide the user interface for the computing system based on the at least one user interface file by playing audio that is defined for the home environment or the business environment.
